(19) United States
(12) Patent Application Publication
(10) Pub. No.: US 2013/0270195 A1
(43) Pub. Date: Oct. 17, 2013

(54) MULTIFUNCTIONAL COMPOSITION FOR THE DISINFECTION TREATMENT OF WATER, AND USE OF THIS COMPOSITION

(71) Applicant: Arnaud Massel, La Grande Motte (FR)

(72) Inventor: Arnaud Massel, La Grande Motte (FR)

(73) Assignee: Compagnie Des Salins Du Midi Et Des Salines De L'Est, Levallois-Perret (FR)

(21) Appl. No.: 13/883,590

(22) PCT Filed: Nov. 9, 2011
(86) PCT No.: PCT/FR11/52613

§ 371 Date: Jun. 25, 2013

(30) Foreign Application Priority Data
Nov. 9, 2010 (FR) 1059262

(51) Int. Cl. C02F 1/467

(52) U.S. Cl. CPC C02F 1/4674
USPC 210/748.2; 424/126

(57) ABSTRACT

A composition for disinfection treatment of swimming pool water by electrochlorination, composition including an alkali chloride and a metasilicate and optionally a chlorine stabilizing agent, for stabilizing against ultraviolet radiation, the use of a composition of this type, and a method involving a composition of this type.

The present invention relates to the field of disinfecting swimming pool water by electrochlorination. More particularly, the invention relates to a multi-functional composition and to its use in the treatment of swimming pool water.

Water may be disinfected by an in situ electrolytic process using a saline sodium chloride solution in order to produce chlorine that is transformed into hypochlorous acid. Examples of water that can be treated in this manner are bathing water, in particular for swimming pools, industrial cooling water, and urban waste water.

French patent FR 2 670 198 may in particular be mentioned from among the prior art compositions; it describes a composition for disinfecting water by means of an electrochlorination method comprising at least one alkali metal chloride and an agent for stabilizing chlorine against UV. The stabilizing agent may in particular be isocyanuric acid in an amount of 0.3% to 0.8% by weight relative to the total weight of salt used in the composition.

However, swimming pool maintenance requires various types of action: not only must the water be disinfected, but the proliferation of algae must also be prevented, deposits of limescale, also known as tartar, must be prevented and/or eliminated, corrosion must be fought, and the formation of stains must be prevented (anti-deposit action and/or action facilitating cleaning of stains).

Patent application FR 2 938 528 describes a multi-functional composition for the disinfection treatment of swimming pool water having disinfectant, anti-algae, anti-limescale, anti-corrosion, and/or anti-staining functions as well as a chlorine stabilizing function.

That composition comprises HEDP (1-hydroxyethane-1,1-diphosphonic acid) as an anti-corrosion, anti-limescale, and anti-staining agent.

However, it has been reported that in some circumstances, adding HEDP to swimming pool water can cause the water to become cloudy. Although such cloudiness is absolutely unconnected to deterioration in the quality of the swimming pool water, that cloudiness is not appreciated by the user, who usually expects the water to be clear and more esthetically pleasing.

Thus, there is still a need for a composition that can completely or largely overcome the problems mentioned above, or at the very least a composition that is multi-functional having regard to the various aspects of water treatment, which in particular can be used to allow the water to be completely or almost completely treated by the action of that single composition, without causing water cloudiness.

Thus, the invention provides a composition for disinfection treatment of swimming pool water by electrochlorination, said composition comprising an alkali metal chloride, a metasilicate, and optionally a chlorine stabilizing agent. Preferably, the composition consists of an alkali metal chloride, a metasilicate, and optionally a chlorine stabilizing agent, and/or a dye. More preferably, the composition consists of an alkali metal chloride, a metasilicate, a chlorine stabilizing agent, and an optional dye.

This composition cannot only be used to disinfect water and optionally to stabilize chlorine, but it can also be used to prevent the deposition of limescale, and to reduce corrosion. It can also prevent the proliferation of algae and it can have an anti-staining action.

The term “anti-staining” as used in the present invention means reducing or even eliminating deposits and/or improving the ease of cleaning of said deposits.

Clearly, the composition of the invention has the majority or all of the functions described when it is used together with an electrolysis apparatus for the production of chlorine.

In addition, use of metasilicate in the composition means that the anti-corrosion and anti-timescale functions are ensured without causing the swimming pool water to become cloudy (see Example 2). The metasilicate also has the advantage of retaining a chlorine stabilizing action (see Example 5) and may have an anti-staining action.

Advantageously, the metasilicate is a disodium metasilicate having the formula Na₂SiO₃. It may be in the anhydrous or hydrated form. Preferably, the disodium metasilicate is in the pentahydrated form.

The amount of disodium metasilicate pentahydrate is ranging from 0.10% to 1.00%, preferably from 0.20% to 0.70%, and more preferably from 0.30% to 0.60% by weight relative to the total weight of alkali chloride, or salt, used in the composition,

More particularly, the composition comprises a quantity of metasilicate such that the quantity of metasilicate ion (SiO₃²⁻) in the water is superior or equal to 1.5 milligrams per liter (mg/L). Most particularly, this quantity may range from 4.5 mg/L to 9 mg/L.

The composition comprises an alkali chloride, in particular sodium chloride. This alkali chloride has the following features in particular:
a minimal alkaline-earth compound content; as an example, the magnesium content may be less than 5 mg/kg, or even less than 3 mg/kg, and/or the calcium content may be less than 500 mg/kg, or even less than 250 mg/kg;
a very low quantity of water-insoluble materials, in particular a quantity of less than 50 mg/kg, in particular less than 30 mg/kg;
a very low oxidizable organic material content;
a very low iron, copper, and manganese content, in particular in order to optimize the electrolytic yield and/or to prevent the risk of corrosion. For example, the quantity of iron may be less than 3 mg/kg, the quantity of copper less than 2 mg/kg, and/or the quantity of manganese may be inferior or equal to 2 mg/kg.

These quantities are given in mg per kg of alkali chloride.

The term “very low content” as used in the present invention means a quantity of 200 mg/kg or less, in particular inferior or equal to 100 mg/kg or less.

The chlorine stabilizing agent, in particular relative to ultraviolet radiation, can be used to limit the destruction by UV of hypochlorite ions originating from the chlorine formed by the electrochlorination process.

Advantageously, the stabilizing agent is isocyanuric acid. It may be present in an amount of 0.3% to 1.0%, preferably in the range 0.5% to 0.9%, more preferably in the range 0.6% to 0.8% by weight relative to the total weight of alkali chloride, or salt, used in the composition.

More particularly, this composition is in solid form, in particular in the form of pebbles, tablets, blocks, pellets, chips, compacted pieces, agglomerates, or granules. These solid forms may be obtained by compressing the mixture.

The solid form of the composition offers a number of advantages; some that may be mentioned are:
improved storage of this composition, in particular compared with a liquid form;
good homogeneity;
good safety, in particular as regards accidental or unintentional ingestion by children;
easy incorporation of components, even in very small quantities; and
easy metering for the user, who adds a given number of solids or sachets comprising the composition.

In a particular embodiment, the composition of the invention could include a coloring agent or dye. In particular, this means that different types of compositions can be distinguished from others as a function of color. Advantageously, the dye is incorporated into the composition in an amount of 0.00005% to 0.005%, preferably 0.0005% to 0.005%, more preferably 0.0005% to 0.002% of the total composition weight. This quantity can be used to obtain a visible coloration of the composition, but not a coloration of the water of the swimming pool after introducing the appropriate quantity. During the manufacturing process, such a quantity may be obtained by spraying the composition in the powder form with a diluted solution of the dye. Advantageously, the dye is diluted with an aqueous solution, for example water. The dye is preferably selected from foodstuff additives, such as E 133.

More particularly, the composition is constituted by sodium chloride, isocyanuric acid, sodium metasilicate, and an optional dye.

This composition can be used to provide a disinfecting action with an appropriate chlorination, a chlorine stabilizing action, an anti-corrosion action, and an anti-limescale action. It may also have an anti-algae action and/or an anti-staining action. Moreover, the combined action of the sodium chloride, the isocyanuric acid, and the metasilicate means that a particularly effective treatment is carried out in respect of the disinfection, anti-corrosion and anti-limescale actions, without generating any secondary effects such as generating cloudiness in the water, and also preserving the chlorine stabilizing action.

In another embodiment, the invention provides the use of a composition in accordance with the invention as a disinfection composition having anti-limescale and anti-corrosion functions and optional chlorine stabilizing, anti-algae and/or anti-staining functions, in particular in the context of the treatment of swimming pool water by electrochlorination.

In yet another embodiment, the invention provides the use of metasilicate, and in particular disodium metasilicate, as an anti-corrosion and anti-timescale and optional anti-staining agent in a disinfection composition for treating swimming pool water.

Again, in another embodiment, the invention provides a method of treating swimming pool water by electrochlorination, the method comprising a step of adding a composition in accordance with the invention to the water. Advantageously, a single composition is added to the swimming pool water. The term “a single composition” means that no additives or supplementary substances are necessary, since the composition of the invention can be used to carry out complete treatment of the water, i.e. treatment comprising all of the actions mentioned above.

Adding the composition of the invention to the water and carrying out electrochlorination are thus sufficient to obtain a disinfecting, anti-corrosion, anti-limescale and optional chlorine stabilizing, anti-staining, and/or anti-algae action. By way of example, when setting up the swimming pool, an effective quantity of the composition of the invention is introduced into the swimming pool water, then the electrochlorination process is started up. Subsequently, for maintenance of the swimming pool, a small quantity of composition is introduced in a regular manner.

The invention can be better understood from the following examples, given purely by way of illustration.

### EXAMPLE 1

Composition in Accordance with the Invention

An example of a composition in accordance with the invention is given in Table 1 below:

TABLE 1

| | % by weight relative to |
|---|---|
| | total weight of sodium |
| Constituent | chloride: |
| isocyanuric acid: | 0.3 to 0.8 |
| disodium metasilicate | 0.20 to 0.75 |
| pentahydrate: | |
| dye: | 0.002 |
| sodium chloride: | qs 100 |

The various constituents were mixed then pressed into the form of 15 grams (g) pellets.

### EXAMPLE 2

### Evolution of Turbidity

The aim of this test was to compare the effect of two compositions comprising sodium chloride and isocyanuric acid in disinfecting swimming pool water, one further comprising HEDP, and the other metasilicate in order to obtain a composition according to the invention.

### Method and Apparatus

In all of the examples below, the substances used were as follows:
salt;
isocyanuric acid;
Aquacid© (powder with 72% HEDP);
disodium metasilicate pentahydrate;
tap water;
commercial bleach (concentration of bleach: 2.15% of active chlorine);
1N hydrochloric acid;
35% sulfuric acid;
sodium hydroxide; and
acetone.

The following proportions were prepared to prepare the samples:

TABLE 2

| | Tap | | | | | Meta |
|---|---|---|---|---|---|---|
| | water | Salt | Iso acid | Chlorine | Aquacid | silicate |
| Sample | (mL) | (g/L) | (mg/L) | (mg/L) | (mg/L) | (mg/L) |
| HEDP | 300.0 | 4.0 | 28.0 | 3.0 | 40.0 | — |
| Meta | 300.0 | 4.0 | 28.0 | 3.0 | — | 40.0 |
| silicate | | | | | | |

The measurement of the turbidity, in NTU (Nephelometric Turbidity Unit), was carried out with the aid of a HACH turbidity meter at the time intervals indicated in Table 3. The reaction conditions were selected in order to accelerate the appearance of any cloudiness.

### Results:

TABLE 3

| | Turbidity | | | | | | |
|---|---|---|---|---|---|---|---|
| | | T + | T + | T + | T + | T + | T + |
| Sample | T | 94 h | 118 h | 142 h | 168 h | 192 h | 216 h |
| HEDP | 0.243 | 20.5 | 22.5 | 30.1 | 34.2 | 44.4 | 56.8 |
| Meta | 0.274 | 0.538 | 0.547 | 0.526 | 0.579 | 1.4 | 1.45 |
| silicate | | | | | | | |

### Conclusion:

It can be seen that, when placed under the same conditions, in contrast to HEDP, metasilicate does not induce any cloudiness of the water in the swimming pool that is detectable to the naked eye.

### EXAMPLE 3

Anti-Timescale Effect of the Composition in Accordance with the Invention

The aim of this test was to analyze the reaction of two additives (HEDP, metasilicate) in the presence of calcium.

### Method and Apparatus:

The apparatus used was as follows:
new beakers with a volume of 400 milliliters (mL), a pH meter, an oven at 70° C., plastic film as well as normal laboratory apparatus (including class A glassware).

The operating protocol can be summarized as follows:
For each test formulation, 300 mL of equivalent swimming pool solution was prepared in the beakers provided. Each series of analyses was spread over two types of water: one with a HT=30° F. and one with a HT=15° F., in order to produce a spectrum of results covering a broad range of water types. The isocyanuric acid was added in the liquid form from a 1 grams per liter (g/L) solution. The additives (HEDP, metasilicate) for the formulations were added in the liquid form from 1 g/L solutions. The solutions were systematically buffered, either with sulfuric acid or with sodium hydroxide, in order to provide an initial pH in the range 6.8 to 7.4 (maximum efficiency range for chlorine). The solutions were left covered with film and were analyzed 3 days later so that the substances had reacted. At the time the analysis was carried out, the beakers were placed in an oven at 70° C. in order to evaporate the liquid phase. They were then rinsed with 100 ml of osmosis purified water in order to eliminate the soluble deposits and to leave only limescale deposits on their walls. The beakers were then refilled with osmosis purified water and 1 mL of 1N hydrochloric acid in order to dissolve the deposits: the measurements were carried out on these solutions.

The parameters below were monitored during the study:
The following were measured for the starting tap water: pH, HT (hydrptimetric titer), calcium, AT (alkalimetric titer), and CAT (complete alkalimetric titer).

The pH was monitored throughout the experiment. The calcium was measured at the end of the experiment.

A summary of the test formulations is given in Table 4 below:

TABLE 4

| | Tap | | | | | Meta |
|---|---|---|---|---|---|---|
| Sample | water | Salt | Iso acid | Chlorine | Aquacid | silicate |
| number | (mL) | (g/L) | (mg/L) | (mg/L) | (mg/L) | (mg/L) |
| 1 | 300.0 | 0.0 | 0.0 | 3.0 | — | — |
| 2 | 300.0 | 4.0 | 0.0 | 3.0 | — | — |
| 11 | 300.0 | 4.0 | 28.0 | 3.0 | 24.0 | — |
| 14 | 300.0 | 4.0 | 28.0 | 3.0 | — | 20.0 |

### Results:

TABLE 5
Characteristics of first starting water:

| | |
|---|---|
| pH | 7.26 |
| HT (° f.) | 27 |
| Calcium | 109 |
| (mg/L) | |
| AT (° f.) | 0 |
| CAT (° f.) | 27.6 |

Efficacy:

| | | | % non |
|---|---|---|---|
| | Sample | Calcium | limescale |
| | number | (mg/L) | calcium |
| Water | 1 | 30.3 | — |
| control | | | |
| Salt | 2 | 24.6 | — |
| control | | | |
| HEDP | 11 | 8.6 | 92.1 |
| Meta | 14 | 3.8 | 96.5 |

The indicated values for calcium correspond to the part of the calcium in the water before treatment that is responsible for the production of limescale. With the metasilicate, only 3.5% of the calcium in the water before treatment was transformed into limescale. This proportion reached 7.9%, 22.6% and 27.8% respectively for the formulation with HEDP and the salt and water controls.

TABLE 6
Characteristics of the second starting water:

| | |
|---|---|
| pH | 7.2 |
| HT (° f.) | 14.6 |
| Calcium | 44.3 |
| (mg/L) | |
| AT (° f.) | 0 |
| CAT (° f.) | 27.6 |

Efficacy:

| | | | % non |
|---|---|---|---|
| | Sample | Calcium | limescale |
| | number | (mg/L) | calcium |
| Water | 1 | 5.6 | — |
| control | | | |
| Salt | 2 | 4.0 | — |
| control | | | |
| HEDP | 11 | 3.8 | 91.4 |
| Meta | 14 | 2.6 | 94.1 |

With the metasilicate, only 5.9% of the calcium of the water before treatment was transformed into limescale. This proportion reached 8.6%, 9.0% and 12.7% respectively for the formulation with HEDP and the salt and water controls.

### Conclusion:

These results demonstrate that HEDP and metasilicate have an anti-limescale activity. In addition, the metasilicate exhibits better anti-limescale activity than that of the HEDP.

### EXAMPLE 4

Anti-Corrosion Effect of the Composition in Accordance with the Invention

The aim was to determine the most effective additive for inhibiting the phenomenon of corrosion that may occur and is a nuisance in the context of a swimming pool (stains on liners, rust on the metallic parts, etc.).

### Method and Apparatus:

The principle of the method consists of completely immersing, in 4 g/L saline solutions with the compounds of the formulations, one steel plate per beaker, disposed vertically in order to have as little contact as possible with the glass. The formulations were those presented in section 4 in Example 3.

The efficacy of the formulations was evaluated as a function of the loss on ignition of the plate over a period of time, namely 2 months.

The following apparatus was used:
400 mL beakers, pH-meter, steel plate with a surface area of 5.3 cm², plastic film as well as normal laboratory apparatus (including class A glassware). The operating protocol can be summarized as follows:

### 1. Preliminary Operations:

stripping the plates with 1N hydrochloric acid using ultrasound in order to have plates of identical quality;
degreasing the plate with acetone in order to obtain identical active surfaces;
weighing the plates with milligram precision.

Swimming pool concentration solutions were prepared in advance in 2 liters (L) graduated flasks in order to provide mutually homogeneous media. The beakers were filled with 300 mL of the above-mentioned solutions. The beakers were covered with food quality film in order to prevent the medium from being polluted and in order to prevent too much evaporation.

The parameters measured were as follows:
on the tap water: pH, HT, AT, CAT, calcium.

### 2. Operations Carried out During Immersion of the Plates:

In order to accelerate the phenomenon of corrosion, bubbling was carried out using an aquarium pump and outlet jets mounted on a rail. The bubbling time was 10 minutes. The solutions were aerated on odd days of the week. Since bubbling raises the pH, it was brought back to swimming pool in-service values, between 6.8 and 7.4. In order to maintain the salinity at 4 g/L and to overcome natural evaporation, tap water was added in order to keep the volume of water constant at 300 mL.

The following parameters were measured:
pH;
observations of the solutions and immersed plates once a day, taking photographs. These observations were made without handling either the beakers or the solutions.

### 3. Final Treatment of Plates:

The scraping spatula was treated with ultrasound then the plates were scraped using the spatula to recover the deposit. In order to terminate stripping of the plate and thus to collect all of the deposit, the plate and the spatula were treated with ultrasound in a water bath. The deposits were then filtered through 10 micrometer (pm) pores and 1.2 μm pores and then dried.

The following parameters were measured:
the plates were weighed to milligram precision;
an iron analysis was carried out on the plates;
a dissolved iron analysis was carried out on the solutions.

The analyses were carried out after 2 months.

### Results:

TABLE 7
Characteristics of starting water:

| | |
|---|---|
| pH | 7.33 |
| HT (° f.) | 40.6 |
| Calcium | 148.7 |
| (mg/L) | |
| AT (° f.) | 0 |
| CAT (° f.) | 27.6 |

Anti-corrosion effect:

| | | Results at 2 months |
|---|---|---|
| | Sample number | Fe loss/plate (%) |
| Water | 1 | 3.54 |
| control | | |
| Salt | 2 | 3.07 |
| control | | |
| HEDP | 11 | 2.80 |
| Metasilicate | 14 | 1.63 |

### Conclusion:

These results demonstrate that the HEDP and the metasilicate have an anti-corrosion activity. In addition, the metasilicate demonstrates an anti-corrosion activity that is even better than that of HEDP.

### EXAMPLE 5

Chlorine Stabilizing Effect of the Composition in Accordance with the Invention

In the presence of UV radiation, chlorine is destroyed photochemically. Isocyanuric acid can be used to reduce the destruction of chlorine under the effect of UV. The aim of this study was to show that the additives of the formulations could be used to maintain the chlorine stabilizing effect.

### Method and Apparatus:

The following apparatus was used: 5 liter volume bucket, pH meter and normal laboratory apparatus (including class A glassware).

The operating procedure can be summarized as follows:
For each test formulation, two liters of solution was prepared in the buckets provided. The isocyanuric acid was added in the liquid form from a 1 g/L solution. The additives (metasilicates, HEDP) for the formulations were added in the liquid form from 1 g/L solutions. The dose of chlorine necessary for this study was provided by bleach in quantities that meant that solutions containing 3 mg/L of Cl₂ were obtained. The solutions were systematically buffered, either with sulfuric acid or with sodium hydroxide, in order to provide a starting pH in the range 6.8 to 7.4 (zone of maximum efficiency for chlorine).

The following parameters were measured during the study:
for the starting water: pH, residual chlorine, HT, calcium, AT, CAT were measured;
throughout the experiment: pH, residual chlorine were monitored.

The chlorine measurements were carried out using quantitative chlorine assay. The measurements were carried out at times T+32 h10 and T+50 h10; the formulation of the compositions at time T are given in Table 4.

### Results:

TABLE 7
Characteristics of starting water:

| | |
|---|---|
| pH | 7.33 |
| Residual | 0.3 |
| chlorine | |
| (mg/L) | |
| HT (° f.) | 40.6 |
| Calcium | 148.7 |
| (mg/L) | |
| AT (° f.) | 0 |
| CAT (° f.) | 27.6 |

Stabilization of chlorine:

| | | T + 32 h 10 | | T + 50 h 10 | |
|---|---|---|---|---|---|
| | | Residual | Loss of | Residual | Loss of |
| | Sample | chlorine | chlorine | chlorine | chlorine |
| | number | (mg/L) | (%) | (mg/L) | (%) |
| HEDP | 11 | 0 | 100.00 | 0 | 100.00 |
| Metasilicate | 14 | 1.89 | 36.36 | 1.1 | 62.96 |

### Conclusion:

These results demonstrate that metasilicate preserves the residual chlorine concentration better than HEDP.

1. A composition for disinfection treatment of swimming pool water by electrochlorination, wherein the composition consists of:
an alkali choloride;
a metasilicate;
optionally, a chlorine stabilizing agent and/or a dye.

2. A composition according to claim 1, wherein a chlorine stabilizing agent is present.

3. A composition according to claim 1, wherein the metasilicate is a sodium metasilicate.

4. A composition according to claim 3, wherein the quantity of sodium metasilicate pentahydrate is 0.10% to 1.0%.

5. A composition according to claim 1, wherein the chlorine stabilizing agent is isocyanuric acid.

6. A composition according to claim 5, wherein the quantity of isocyanuric acid is 0.3% to 1.0%.

7. A composition according to claim 1, in the solid form.

8. (canceled)

9. A method of treating swimming pool water by electrochlorination in order to carry out a disinfecting, anti-corrosion and anti-limescale action and optionally a chlorine stabilizing, anti-algae and/or anti-staining action, comprising a step of adding a composition according to claim 1, to the water.

10. (canceled)
